(19) United States
(12) Patent Application Publication
(10) Pub. No.: US 2026/0217090 A1
(43) Pub. Date: Jul. 30, 2026

(54) POWER TRANSMISSION MECHANISM

(71) Applicant: TOYODA GOSEI CO., LTD., Kiyosu-shi (JP)

(72) Inventor: Hironori TAKAGI, Kiyosu-shi (JP)

(21) Appl. No.: 19/445,941

(22) Filed: Jan. 12, 2026

(30) Foreign Application Priority Data
Jan. 30, 2025 (JP) 2025-013749

(51) Int. Cl. B60H 1/34

(52) U.S. Cl. CPC B60H 1/3414; B60H 2001/3471

(57) ABSTRACT

A power transmission mechanism includes a rotation shaft, a drive gear, an intermediate member, a first output portion, and a second output portion. The rotation shaft is configured to rotate about a central axis. The drive gear is attached to the rotation shaft so as to rotate integrally therewith. The intermediate member is configured to be swung about the rotation shaft between a first position and a second position by the torque of the drive gear. The first output portion is configured to drive the first driven member by being connected to the intermediate member in a power transmittable manner when the intermediate member swings to the first position. The second output portion is configured to drive the second driven member by being connected to the intermediate member in a power transmittable manner when the intermediate member swings to the second position.

### CROSS-REFERENCE TO RELATED APPLICATIONS

This application is based upon and claims the benefit of priority from Japanese Patent Application No. 2025-013749, filed on January 30, 2025, the entire contents of which are incorporated herein by reference.

### BACKGROUND

### 1. Field

The present disclosure relates to a power transmission mechanism.

### 2. Description of Related Art

JP2008-1151A discloses, in the third embodiment, an air-conditioning register that adjusts at least the direction of air-conditioning air delivered from an air conditioner and discharged into a passenger compartment.

The air-conditioning register includes, as two driven members, an upstream fin and a downstream fin, which is disposed downstream of the upstream fin in the flow direction of the air-conditioning air. The upstream fin and the downstream fin are tilted in the vertical direction about their respective shafts so as to vertically adjust the discharge direction of the air-conditioning air.

The air-conditioning register includes a power transmission mechanism that drives the upstream fin and the downstream fin using power transmitted from a single power source.

The power transmission mechanism includes an upstream gear, a downstream gear, a transmission gear, and an operation dial. The upstream gear is mounted on the shaft of the upstream fin so as to rotate integrally therewith. The downstream gear is mounted on the shaft of the downstream fin so as to rotate integrally therewith and is meshed with the upstream gear. The transmission gear is disposed downstream of the downstream gear in the flow direction and is meshed with the downstream gear. The operation dial is disposed downstream of the transmission gear in the flow direction. A gear provided on the outer peripheral portion of the operation dial is meshed with the transmission gear.

When the operation dial is rotated by an occupant, both the downstream gear and the upstream gear are rotated via the transmission gear. The upstream fin and the downstream fin are tilted about the respective shafts in opposite directions to vertically adjust the discharge direction of the air-conditioning air.

However, in the above-described power transmission mechanism, rotation of the operation dial causes the upstream gear and the downstream gear to rotate simultaneously. Consequently, both the upstream fin and the downstream fin tilt at the same time. Compared with a configuration in which the upstream gear and the downstream gear can be rotated independently so that the upstream fin and the downstream fin can be tilted separately, it is difficult in this configuration to finely adjust the discharge direction of the air-conditioning air.

Such a problem can arise not only in the power transmission mechanism provided in the air-conditioning register, but also generally in any power transmission mechanism that drives two driven members using power transmitted from a single power source.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a power transmission mechanism includes a rotation shaft, a drive gear, an intermediate member, a first output portion, and a second output portion. The rotation shaft is configured to rotate about a central axis. A rotational direction of the rotation shaft is switchable. The drive gear is attached to the rotation shaft so as to rotate integrally therewith. The intermediate member is configured to swing about the rotation shaft between a first position and a second position in a rotational direction of the rotation shaft by a torque of the drive gear. The first output portion is configured to drive a first driven member by being connected to the intermediate member in a power transmittable manner when the intermediate member swings to the first position. The second output portion is configured to drive a second driven member by being connected to the intermediate member in a power transmittable manner when the intermediate member swings to the second position.

Other features and aspects will be apparent from the following detailed description, the drawings, and the claims.

### BRIEF DESCRIPTION OF THE DRAWINGS

FIG. 1 is a perspective view of a power transmission mechanism according to an embodiment as viewed from the inner side.

FIG. 2 is a perspective view of the power transmission mechanism according to the embodiment as viewed from the outer side.

FIG. 3 is a schematic diagram illustrating the relationship among the power transmission mechanism, a motor, and driven members in the embodiment when an intermediate member is located at a first position.

FIG. 4 is a partial cross-sectional view illustrating a swing control unit of the embodiment.

FIG. 5 is a schematic diagram of the power transmission mechanism when the intermediate member is located at a second position in the embodiment.

FIG. 6 is a schematic diagram of the power transmission mechanism when the rotational direction of a rotation shaft is switched from that in the state of FIG. 3 and the torque of a drive gear is less than a prescribed value.

FIG. 7 is a schematic diagram of the power transmission mechanism when the rotational direction of a rotation shaft is switched from that in the state of FIG. 5 and the torque of the drive gear is less than the prescribed value.

FIG. 8 is a schematic diagram showing a power transmission mechanism according to a modification provided with a swing control unit of a type different from that of the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

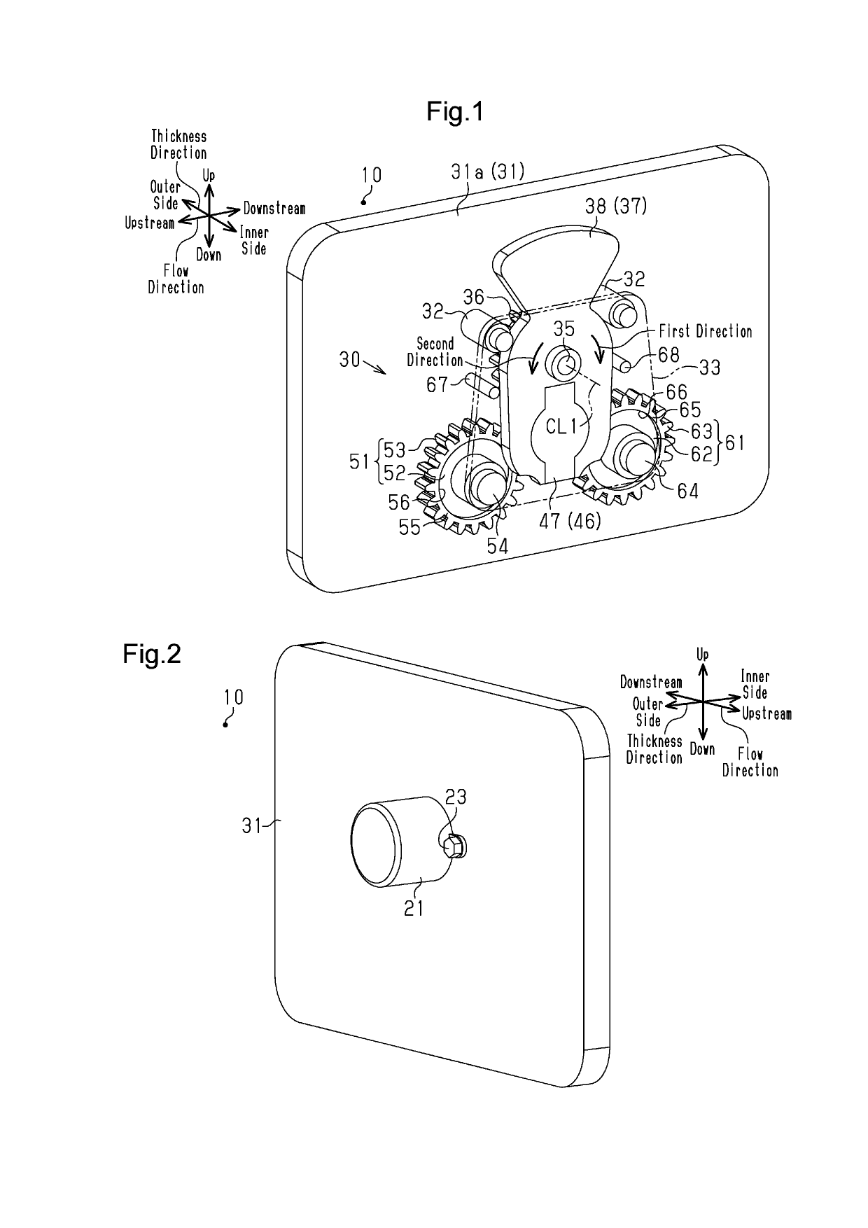

A power transmission mechanism in an air-conditioning register for a vehicle according to an embodiment will now be described with reference to FIGS. 1 to 7.

In the following description, the direction in which a vehicle 10 advances forward will be referred to as the front, and the reverse direction will be referred to as the rear. The vertical direction corresponds to the up-down direction of the vehicle 10. The lateral direction corresponds to the vehicle width direction, which agrees with the left-right direction when the vehicle 10 is advancing forward.

The vehicle 10 includes air-conditioning registers that are installed in the instrument panel in the passenger compartment. Each air-conditioning register changes the direction of air-conditioning air, which is delivered from the air conditioner and discharged into the passenger compartment through air outlets. One form of such an air-conditioning register is known as a cross-louver type. This type of air-conditioning register includes a retainer with an air passage.

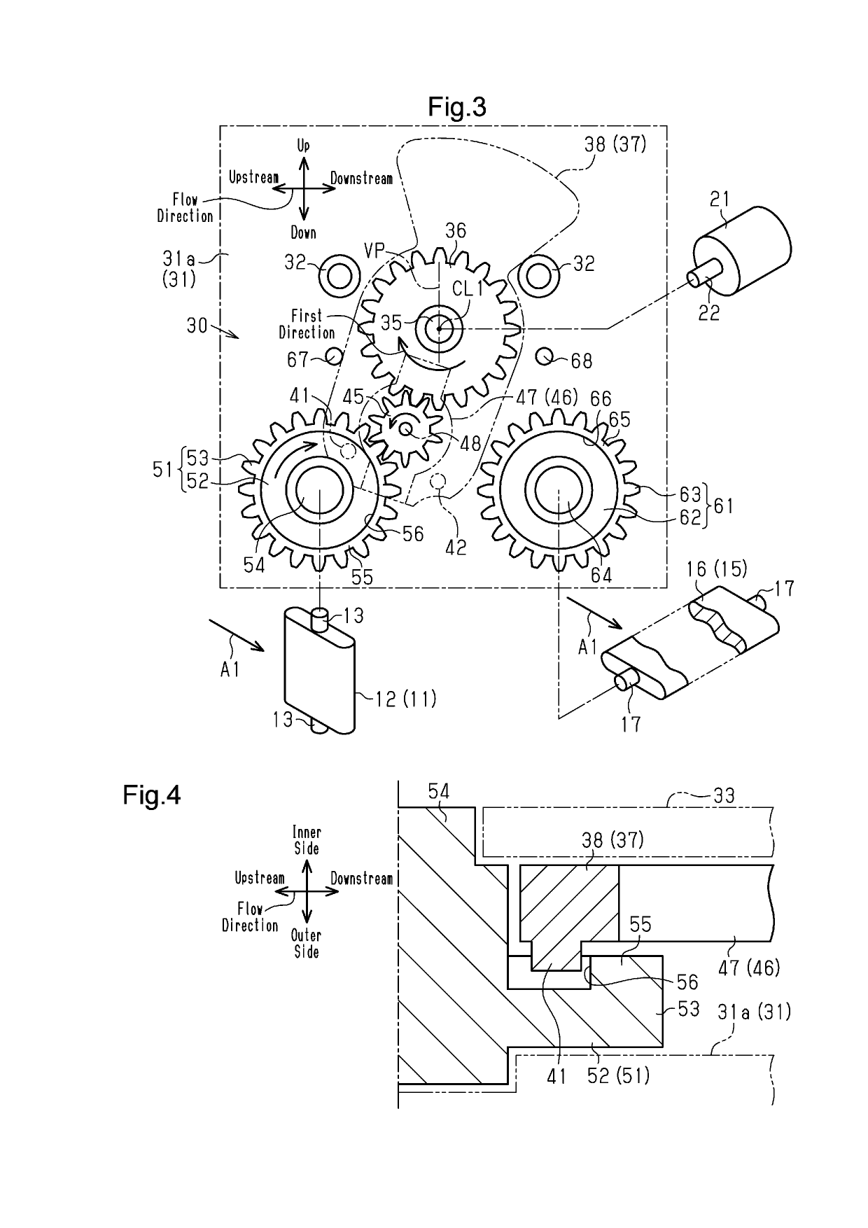

With regard to the direction in which air-conditioning air A1 shown in FIG. 3 flows, the side closer to the air conditioner will be referred to as an upstream side, and the side farther from the air conditioner will be referred to as a downstream side. The air passage includes an air outlet at the downstream end. An upstream fin 11 is disposed as a first driven member in the air passage. The upstream fin 11 includes a plate-shaped body 12 extending in the flow direction of the air-conditioning air A1 and in the vertical direction, and shaft portions 13 provided at the opposite ends of the body 12 in the vertical direction.

In the air passage, a downstream fin 15 is disposed as a second driven member on the downstream side of the upstream fin 11 and on the upstream side of the air outlet in the flow direction. The downstream fin 15 includes a plate-shaped body 16 extending in the flow direction and the lateral direction, and shaft portions 17 provided at the opposite ends of the body 16 in the lateral direction. In FIG. 3, an intermediate portion of the body 16 in the lateral direction is not shown.

In the above-described air-conditioning register, the air-conditioning air A1 flowing through the air passage flows along the body 12 of the upstream fin 11 and the body 16 of the downstream fin 15 in that order, and then is discharged from the air outlet. When the body 12 is tilted about the shaft portions 13, the discharge direction of the air-conditioning air A1 in the lateral direction is changed. When the body 16 is tilted about the shaft portions 17, the discharge direction of the air-conditioning air A1 in the vertical direction is changed.

The air-conditioning register includes a power transmission mechanism 30 that drives the upstream fin 11 and the downstream fin 15 using power transmitted from a single power source. In the present embodiment, a motor 21 is used as the power source.

As shown in FIG. 1, the power transmission mechanism 30 includes a plate-shaped base 31. The base 31 is disposed in a state in which the thickness direction agrees with the lateral direction of the vehicle 10. The flow direction of the air-conditioning air A1 is orthogonal to the thickness direction and the vertical direction. One side of the base 31 in the thickness direction is referred to as the “outer side” or “outside,” and the other side is referred to as the “inner side” or “inside.”

As shown in FIGS. 1 and 3, two columns 32 protrude inward from an inner surface 31a of the base 31. The two columns 32 are spaced apart from each other in the flow direction. A support plate 33 indicated by long-dash double-short-dash lines in FIG. 1 is disposed on the inner side of the base 31. The support plate 33 is fixed to the inner ends of the two columns 32. The support plate 33 is not shown in FIGS. 3 and 5 to 8.

### Motor 21

As shown in FIGS. 1 to 3, the motor 21 is fastened to the base 31 from the outside with a fastening member 23 such as a bolt. The motor 21 includes an output shaft 22 that rotates in a first direction and rotates in a second direction opposite to the first direction. The motor 21 is configured to switch the rotational direction of the output shaft 22. The output shaft 22 extends through the base 31 in the thickness direction.

The power transmission mechanism 30 further includes a rotation shaft 35, a drive gear 36, an intermediate member 37, a first output portion, a second output portion, a first stopper 67, a second stopper 68, and a swing control unit. Next, each component will be described.

### Rotation Shaft 35

The rotation shaft 35 extends in the thickness direction and is supported by the support plate 33 so as to be rotatable relative to the support plate 33. The rotation shaft 35 is disposed coaxially with the output shaft 22 of the motor 21. The rotation shaft 35 is coupled to the output shaft 22 so as to rotate integrally therewith. The rotation shaft 35 rotates about a central axis CL1 integrally with the output shaft 22. The rotational direction of the rotation shaft 35 is switched by the motor 21.

### Drive Gear 36

As shown in FIGS. 1 and 3, the drive gear 36 is disposed between the base 31 and the intermediate member 37 in the thickness direction. The drive gear 36 is attached to the rotation shaft 35 so as to rotate integrally therewith.

### Intermediate Member 37

The intermediate member 37 includes a swing member 38, an intermediate gear 45, and a resistance applying unit. The swing member 38 has the shape of a plate. The thickness direction of the swing member 38 agrees with the thickness direction of the base 31. The swing member 38 is supported by the rotation shaft 35 so as to be rotatable relative to the rotation shaft 35. A part of the swing member 38 is disposed between the base 31 and the support plate 33 in the thickness direction. The remaining portion of the swing member 38 is exposed upward from between the base 31 and the support plate 33. The swing member 38 is swingable in the flow direction about the rotation shaft 35 between a first position and a second position in the rotational direction of the rotation shaft 35.

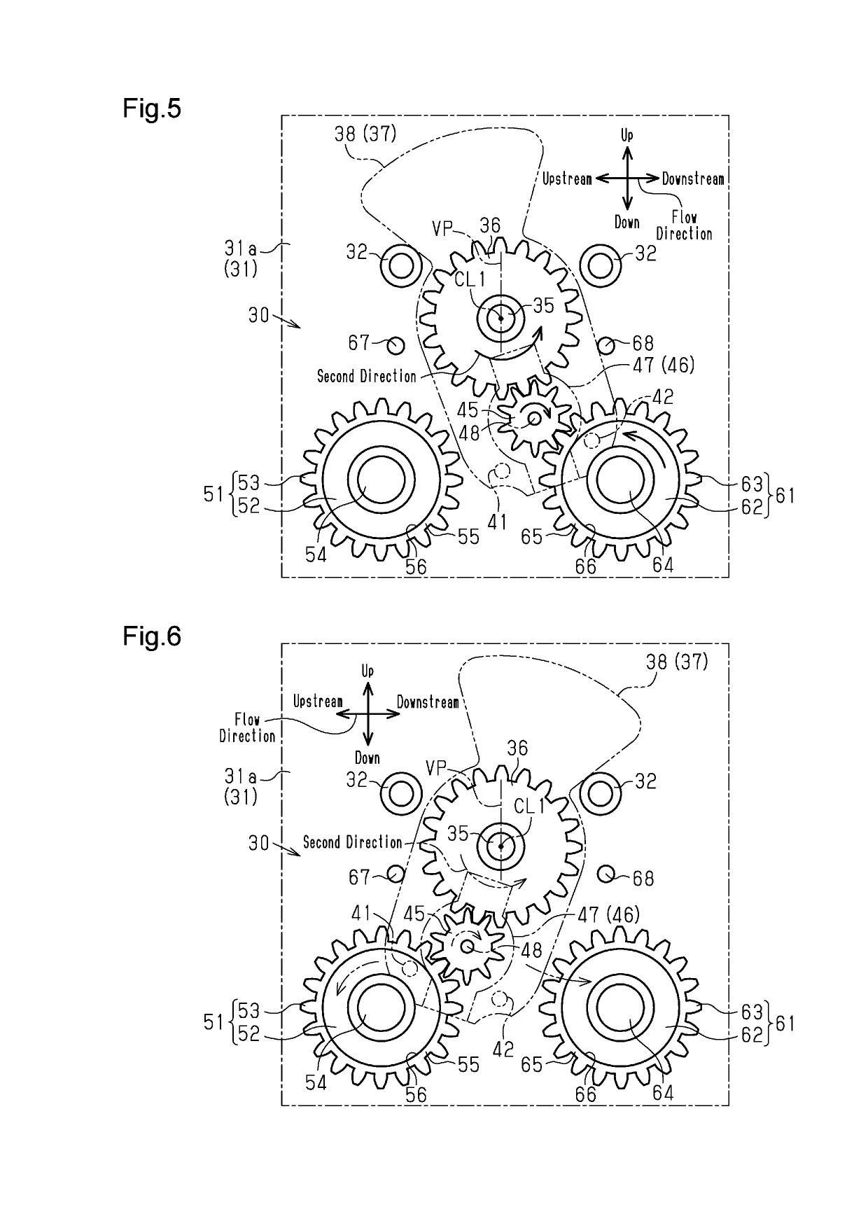

As shown in FIG. 3, the first position is a position at which the swing member 38 is inclined with respect to a vertical plane VP including the central axis CL1, such that its lower portion is located further upstream in the above-mentioned flow direction. As shown in FIG. 5, the second position is a position at which the swing member 38 is inclined with respect to the vertical plane VP, such that its lower portion is located further downstream in the flow direction.

As shown in FIG. 3, the intermediate gear 45 is disposed on the lower side of the drive gear 36 on the outer periphery of the drive gear 36, and meshes with the drive gear 36.

The resistance applying unit includes a damper. The damper is attached to a portion of the swing member 38 below the rotation shaft 35. In the present embodiment, a rotary damper 46 that reduces the rotational speed of the intermediate gear 45 is used as a damper.

The rotary damper 46 includes a housing 47, a rotor (not shown) rotatably accommodated in the housing 47, and a shaft 48 coupled to the rotor so as to rotate integrally therewith. A viscous fluid (not shown) such as oil is interposed between the housing 47 and the rotor in the housing 47.

The intermediate gear 45 is attached to the shaft 48 of the rotary damper 46 so as to rotate integrally with the shaft 48. The rotary damper 46 generates torque during rotation of the rotor and the shaft 48 due to viscous resistance of the viscous fluid. By this torque, the rotary damper 46 applies resistance in the rotational direction to the drive gear 36 via the intermediate gear 45. A correlation exists between the torque generated by the rotary damper 46 and the rotational speed of the shaft 48. As the rotational speed increases, the torque increases. As the rotational speed decreases, the torque decreases. By virtue of this characteristic, the rotary damper 46 increases the torque of the drive gear 36 through the intermediate gear 45 as the rotational speed of the drive gear 36 rises.

### First Output Portion and Second Output Portion

As shown in FIGS. 1 and 3, the first output portion includes a first output gear 51. The second output portion includes a second output gear 61. The first output gear 51 includes a disc-shaped first gear body 52 and a first tooth portion 53 formed on the outer periphery of the first gear body 52. The second output gear 61 includes a disc-shaped second gear body 62 and a second tooth portion 63 formed on the outer periphery of the second gear body 62. The first output gear 51 and the second output gear 61 are disposed at positions satisfying the following conditions.

Condition 1: The positions are lower than the drive gear 36.

Condition 2: The positions are separated from the drive gear 36.

Condition 3: The positions are separated from each other in the flow direction.

In the present embodiment, the first output gear 51 and the second output gear 61 are disposed at positions that are symmetrical with respect to the vertical plane VP. The first output gear 51 is disposed at a position separated from the vertical plane VP toward the upstream side. The second output gear 61 is disposed at a position away from the vertical plane VP toward the downstream side.

The first output gear 51 is supported by a first shaft 54 so as to be rotatable with respect to the base 31 and the support plate 33. In a case in which the first output gear 51 is fixed to the first shaft 54, the first shaft 54 is rotatably supported by the base 31 and the support plate 33. In a case in which the first output gear 51 is rotatable relative to the first shaft 54, the first shaft 54 is fixed to at least one of the base 31 and the support plate 33. The first output gear 51 is meshed with the intermediate gear 45 of the intermediate member 37 swung to the first position, so that the first output gear 51 is connected to the intermediate member 37 in a power transmittable manner. This connection allows the rotation of the drive gear 36 to be transmitted to the first output gear 51 via the intermediate gear 45. When the first output gear 51 rotates, the upstream fin 11 shown in FIG. 3 is tilted in the lateral direction about the shaft portions 13.

As shown in FIGS. 1 and 5, the second output gear 61 is supported by the second shaft 64 to be rotatable with respect to the base 31 and the support plate 33. In a case in which the second output gear 61 is fixed to the second shaft 64, the second shaft 64 is rotatably supported by the base 31 and the support plate 33. In a case in which the second output gear 61 is rotatable relative to the second shaft 64, the second shaft 64 is fixed to at least one of the base 31 and the support plate 33. The second output gear 61 is meshed with the intermediate gear 45 of the intermediate member 37 swung to the second position, so that the second output gear 61 is connected to the intermediate member 37 in a power transmittable manner. This connection allows the rotation of the drive gear 36 to be transmitted to the second output gear 61 via the intermediate gear 45. When the second output gear 61 rotates, the downstream fin 15 shown in FIG. 3 is tilted in the vertical direction about the shaft portions 17.

The First Stopper 67 and The Second Stopper 68.

As shown in FIGS. 1 and 3, the first stopper 67 restricts the swing member 38 from swinging in a direction away from the second position beyond the first position. The first stopper 67 includes a pin extending in the thickness direction. The first stopper 67 is fixed to at least one of the base 31 and the support plate 33. The first stopper 67 is disposed on the upstream side of the swing member 38 and at a position where the first stopper 67 comes into contact with the swing member 38 swung to the first position from the upstream side.

As shown in FIGS. 1 and 5, the second stopper 68 includes a pin extending in the thickness direction. The second stopper 68 is fixed to at least one of the base 31 and the support plate 33. The second stopper 68 is disposed on the downstream side of the swing member 38 and at a position where the second stopper 68 comes into contact with the swing member 38 swung to the second position from the downstream side.

### Swing Control Unit

As shown in FIGS. 1, 3, and 4, the swing control unit is configured to control the swinging motion of the swing member 38 in accordance with the magnitude of the torque of the drive gear 36. The swing control unit includes a first stepped portion 55 formed on the first output gear 51, a second stepped portion 65 formed on the second output gear 61, and a first engagement portion 41 and a second engagement portion 42 respectively provided on the swing member 38.

The first stepped portion 55 is formed in an annular shape on the outer peripheral portion of the first gear body 52. The first gear body 52 includes a first annular recess 56 having a circular shape. In the radial direction, the first annular recess 56 is located on the inner side of the first stepped portion 55 and on the outer side of the first shaft 54.

The second stepped portion 65 is formed in an annular shape on the outer peripheral portion of the second gear body 62. The second gear body 62 includes a second annular recess 66 having a circular shape. In the radial direction, the second annular recess 66 is located on the inner side of the second stepped portion 65 and on the outer side of the second shaft 64.

The first engagement portion 41 and the second engagement portion 42 protrude outward from the swing member 38. The first engagement portion 41 and the second engagement portion 42 are located at positions separated from each other in the swing direction of the swing member 38. The first engagement portion 41 and the second engagement portion 42 may be formed integrally with the swing member 38, or may be components formed separately from the swing member 38.

As shown in FIGS. 3 and 4, when the swing member 38 is located at the first position, the distal end of the first engagement portion 41 is located in the first annular recess 56 and at a position close to the first stepped portion 55. As shown in FIG. 5, when the swing member 38 is located at the second position, the distal end of the second engagement portion 42 is located in the second annular recess 66 and at a position close to the second stepped portion 65. When the swing member 38 swings between the first position and the second position, the respective distal ends of the first engagement portion 41 and the second engagement portion 42 are located between the first stepped portion 55 and the second stepped portion 65.

### Operation of the Present Embodiment

As shown in FIG. 3, in the air-conditioning register, the air-conditioning air A1 delivered from the air conditioner to the retainer flows along the body 12 of the upstream fin 11 and the body 16 of the downstream fin 15 while flowing through the air passage. At this time, the air-conditioning air A1 flows in a direction corresponding to the inclination of each of the bodies 12, 16. The air-conditioning air A1 is then discharged from the air outlet.

When the output shaft 22 of the motor 21 is rotated in the first direction, the rotation shaft 35, which is coupled to the output shaft 22, is rotated in the first direction about the central axis CL1 together with the drive gear 36 as indicated by a solid arrow in FIG. 3.

The rotary damper 46 applies a resistance in the rotational direction to the intermediate gear 45, which is meshed with the drive gear 36. This resistance is transmitted to the swing member 38 via the drive gear 36.

Accordingly, when the rotation shaft 35 is rotated in the first direction together with the drive gear 36 as described above, the intermediate member 37 is swung about the rotation shaft 35 toward the first position in the rotational direction of the rotation shaft 35 by the torque of the drive gear 36.

Immediately before the swing member 38 swings to the first position, the first engagement portion 41 passes over the first stepped portion 55, so that the distal end of the first engagement portion 41 enters the first annular recess 56. After entering the first annular recess 56, the distal end of the first engagement portion 41 is located at a position within the first annular recess 56 that is close to the first stepped portion 55.

When the intermediate member 37 swings to the first position, the intermediate gear 45 meshes with the first output gear 51 to transmit power (rotation) to the first output gear 51. In this manner, the drive gear 36 and the first output gear 51 are connected to each other via the intermediate member 37 in a power transmittable manner. This allows rotation of the drive gear 36 to be transmitted to the first output gear 51 via the intermediate gear 45. When the first output gear 51 is rotated, the upstream fin 11 is tilted in the lateral direction about the shaft portions 13. As the air-conditioning air A1 flows along the body 12 of the tilted upstream fin 11, the direction in which air is discharged from the air outlet is changed laterally.

At this time, since the rotation of the drive gear 36 is not transmitted to the second output gear 61 via the intermediate gear 45, the downstream fin 15 is not tilted. The downstream fin 15 maintains the inclined state that existed immediately before the rotation shaft 35 starts to rotate in the first direction.

As described above, when the intermediate gear 45 meshes with the first output gear 51 by the swinging motion of the swing member 38 to the first position, the swing member 38 comes in contact with the first stopper 67. Due to this contact, the first stopper 67 restricts the swing member 38 from swinging in a direction away from the second position beyond the first position.

When the rotational direction of the output shaft 22 is switched from the first direction to the second direction in the above-described state, the rotation shaft 35, which is coupled to the output shaft 22, is rotated in the second direction together with the drive gear 36 as indicated by long-dash double-short-dash lines in FIG. 6.

The rotary damper 46 applies a resistance in the rotational direction to the intermediate gear 45, which is meshed with the drive gear 36. The applied resistance is transmitted to the swing member 38 via the drive gear 36, which is meshed with the intermediate gear 45.

Further, the resistance in the rotation direction applied by the rotary damper 46 via the intermediate gear 45 causes the torque of the drive gear 36 to increase as the rotation speed increases.

When the torque of the drive gear 36 is less than a prescribed value set in advance due to a relatively low rotational speed of the drive gear 36, the swing control unit restricts the swing member 38 from swinging from the first position to the second position.

Specifically, when the swing member 38 is located at the first position and the torque of the drive gear 36 is less than the prescribed value, the distal end of the first engagement portion 41 is in the first annular recess 56 (see FIG. 4). The distal end of the first engagement portion 41 is located at a position within the first annular recess 56 that is close to the first stepped portion 55. In this state, when the rotational direction of the drive gear 36 is switched to the second direction and the swing member 38 tends to swing in the opposite direction, the distal end of the first engagement portion 41 is located in the first annular recess 56 since the torque of the drive gear 36 is less than the prescribed value. The distal end of the first engagement portion 41 comes into contact with the first stepped portion 55, but is prevented from passing over the first stepped portion 55. Accordingly, the swinging motion of the swing member 38 from the first position to the second position is restricted. As a result of this swing restriction, the intermediate gear 45 is maintained in a meshed state with the first output gear 51.

In contrast, when the torque of the drive gear 36 becomes greater than or equal to the prescribed value as the rotational speed of the drive gear 36 increases, the first engagement portion 41 passes over the first stepped portion 55. This passing over allows the swing member 38 to swing from the first position to the second position.

Immediately before the swing member 38 swings to the second position, the second engagement portion 42 passes over the second stepped portion 65, so that the distal end of the second engagement portion 42 enters the second annular recess 66, as shown in FIG. 5.

When the intermediate member 37 swings to the second position, the intermediate gear 45 meshes with the second output gear 61, thereby transmitting power (rotation) to the second output gear 61.

In this manner, the drive gear 36 and the second output gear 61 are connected to each other via the intermediate member 37 in a power transmittable manner. This allows rotation of the drive gear 36 to be transmitted to the second output gear 61 via the intermediate gear 45. The output gear with which the intermediate gear 45 meshes is switched from the first output gear 51 to the second output gear 61. When the second output gear 61 is rotated, the downstream fin 15 shown in FIG. 3 is tilted in the vertical direction about the shaft portions 17. As the air-conditioning air A1 flows along the body 16 of the tilted downstream fin 15, the direction in which air is discharged from the air outlet is changed vertically.

At this time, since the rotation of the drive gear 36 is not transmitted to the first output gear 51 via the intermediate gear 45 as shown in FIG. 5, the upstream fin 11 is not tilted. The upstream fin 11 maintains the inclined state that existed before the rotational direction of the rotation shaft 35 is switched.

As described above, when the intermediate gear 45 meshes with the second output gear 61 by the swinging motion of the swing member 38 to the second position, the swing member 38 comes in contact with the second stopper 68. Due to this contact, the second stopper 68 restricts the swing member 38 from swinging in a direction away from the first position beyond the second position. Further, at this time, the distal end of the second engagement portion 42 is located at a position within the second annular recess 66 that is close to the second stepped portion 65.

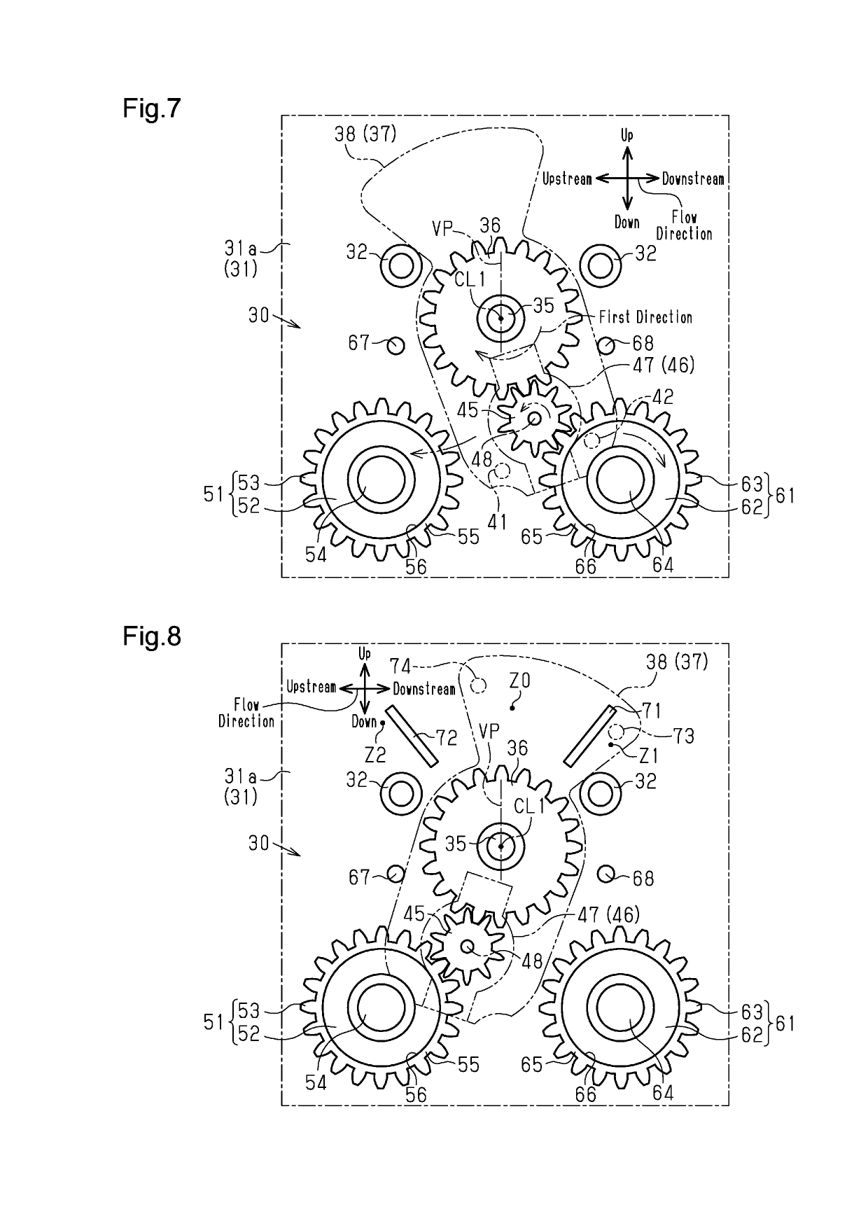

When the rotational direction of the output shaft 22 is switched from the second direction to the first direction in the above-described state, the rotation shaft 35, which is coupled to the output shaft 22, is rotated in the first direction together with the drive gear 36 as indicated by long-dash double-short-dash lines in FIG. 7.

The rotary damper 46 applies a resistance in the rotational direction to the intermediate gear 45, which is meshed with the drive gear 36. The applied resistance is transmitted to the swing member 38 via the drive gear 36, which is meshed with the intermediate gear 45.

Further, the resistance in the rotation direction applied by the rotary damper 46 via the intermediate gear 45 causes the torque of the drive gear 36 to increase as the rotation speed increases.

When the torque of the drive gear 36 is less than the prescribed value due to a relatively low rotational speed of the drive gear 36, the swing control unit restricts the swing member 38 from swinging from the second position to the first position.

Specifically, when the swing member 38 is located at the second position and the torque of the drive gear 36 is less than the prescribed value, the distal end of the second engagement portion 42 is in the second annular recess 66. The distal end of the second engagement portion 42 is located at a position within the second annular recess 66 that is close to the second stepped portion 65. The distal end of the second engagement portion 42 comes into contact with the second stepped portion 65, but is prevented from passing over the second stepped portion 65. Accordingly, the swinging motion of the swing member 38 from the second position to the first position is restricted. As a result of this restriction, the intermediate gear 45 is maintained in a meshed state with the second output gear 61.

In contrast, when the torque of the drive gear 36 becomes greater than or equal to the prescribed value as the rotational speed of the drive gear 36 increases, the second engagement portion 42 passes over the second stepped portion 65. This passing over allows the swing member 38 to swing from the second position to the first position.

Immediately before the swing member 38 swings to the first position, the first engagement portion 41 passes over the first stepped portion 55, so that the distal end of the first engagement portion 41 enters the first annular recess 56, as shown in FIG. 3.

When the intermediate member 37 swings to the first position, the intermediate gear 45 meshes with the first output gear 51 to transmit power (rotation) to the first output gear 51.

In this manner, the drive gear 36 and the first output gear 51 are connected to each other via the intermediate member 37 in a power transmittable manner. This allows rotation of the drive gear 36 to be transmitted to the first output gear 51 via the intermediate gear 45. The output gear with which the intermediate gear 45 meshes is switched from the second output gear 61 to the first output gear 51. When the first output gear 51 is rotated, the upstream fin 11 shown in FIG. 3 is tilted in the lateral direction about the shaft portions 13. As the air-conditioning air A1 flows along the body 12 of the tilted upstream fin 11, the direction in which air is discharged from the air outlet is changed laterally.

At this time, since the rotation of the drive gear 36 is not transmitted to the second output gear 61 via the intermediate gear 45, the downstream fin 15 is not tilted. The downstream fin 15 maintains the inclined state that existed immediately before the rotational direction of the rotation shaft 35 is switched.

At this time, the distal end of the first engagement portion 41 is located at a position within the first annular recess 56 that is close to the first stepped portion 55.

### Advantages of the Present Embodiment

(1) As shown in FIG. 1, the power transmission mechanism 30 includes the rotation shaft 35, of which the rotational direction is switchable, the drive gear 36, which is attached to the rotation shaft 35 so as to rotate integrally therewith, the intermediate member 37, the first output portion, and the second output portion. The intermediate member 37 is swung between the first position and the second position in the rotational direction of the rotation shaft 35 by the torque of the drive gear 36. When the intermediate member 37 swings to the first position shown in FIG. 3, the intermediate member 37 is connected to the first output portion in a power transmittable manner, thereby driving the first driven member (the upstream fin 11). Further, when the intermediate member 37 swings to the second position shown in FIG. 5, the intermediate member 37 is connected to the second output portion in a power transmittable manner, thereby driving the second driven member (downstream fin 15).

Accordingly, by selectively switching one of two driven members, namely, the upstream fin 11 and the downstream fin 15, to which power is transmitted from a single power source (the motor 21), each driven member is driven independently.

(2) As shown in FIGS. 1 and 3, the first output gear 51 is used as a part of the first output portion, and the second output gear 61 is used as a part of the second output portion. The swing member 38 of the intermediate member 37 is swung between the first position and the second position. The intermediate gear 45 of the intermediate member 37 is rotatably supported by the swing member 38 and meshes with the drive gear 36. When the swing member 38 swings to the first position shown in FIG. 3, the intermediate gear 45 meshes with the first output gear 51 to transmit power to the first output gear 51. When the swing member 38 swings to the second position shown in FIG. 5, the intermediate gear 45 meshes with the second output gear 61 to transmit power to the second output gear 61. Further, the resistance applying unit applies resistance in the rotational direction to the intermediate gear 45.

By applying this resistance, the intermediate member 37 is swung to the first position shown in FIG. 3. The rotation of the drive gear 36 is then transmitted to the first output gear 51 via the intermediate gear 45. This rotates the first output gear 51 and drives the first target member (the upstream fin 11). By switching the rotational direction of the rotation shaft 35, the intermediate member 37 is swung to the second position shown in FIG. 5. The rotation of the drive gear 36 is then transmitted to the second output gear 61 via the intermediate gear 45. This rotates the second output gear 61 and drives the second target member (the downstream fin 15).

(3) As shown in FIGS. 1 to 3, the motor 21, which is configured to switch the rotational direction of the output shaft 22, is used as a power source, and the output shaft 22 is coupled to the rotation shaft 35 so as to rotate integrally therewith.

Accordingly, by rotating the output shaft 22 of the motor 21 in the first direction, the intermediate member 37 is swung to the first position shown in FIG. 3. Further, by rotating the output shaft 22 of the motor 21 in the second direction, the intermediate member 37 is swung to the second position shown in FIG. 5.

(4) The power transmission mechanism 30 includes the first stopper 67 and the second stopper 68. The first stopper 67 restricts the swing member 38 from swinging in a direction away from the second position beyond the first position shown in FIG. 3. The second stopper 68 restricts the swing member 38 from swinging in a direction away from the first position beyond the second position shown in FIG. 5.

Accordingly, it is possible to prevent the intermediate gear 45 from becoming disengaged from the first output gear 51 due to the swinging motion of the swing member 38 in a direction away from the second position beyond the first position. Also, it is possible to prevent the intermediate gear 45 from becoming disengaged from the second output gear 61 due to the swinging motion of the swing member 38 in a direction away from the first position beyond the second position.

(5) As shown in FIGS. 3 and 5, the torque applying unit increases the torque of the drive gear 36 via the intermediate gear 45. When the torque of the drive gear 36 is less than the prescribed value, the swinging motion of the swing member 38 from the first position to the second position is restricted, and the swinging motion of the swing member 38 from the second position to the first position is restricted. Further, when the torque of the drive gear 36 becomes greater than or equal to the prescribed value, the swinging motion of the swing member 38 from the first position to the second position is permitted, and the swinging motion of the swing member 38 from the second position to the first position is permitted.

Accordingly, by changing the magnitude of the torque of the drive gear 36 via the intermediate gear 45, the intermediate member 37 is permitted to swing from the first position to the second position and from the second position to the first position.

(6) As shown in FIG. 3, the rotary damper 46 is used as the resistance applying unit. The rotary damper 46 includes the rotatable shaft 48, and generates torque using viscous fluid when the shaft 48 rotates.

Accordingly, the intermediate gear 45 is attached to the shaft 48 of the rotary damper 46 attached to the swing member 38 so as to rotate integrally with the shaft 48, and the intermediate gear 45 is meshed with the drive gear 36. In this manner, resistance is applied to the rotation of the drive gear 36 via the intermediate gear 45.

### Modifications

The above-described embodiment may be modified as follows. The above-described embodiment and the following modifications can be combined if the combined modifications remain technically consistent with each other.

An actuator other than the motor 21 may be employed as a power source as long as the actuator rotates the rotation shaft 35. Alternatively, the rotation shaft 35 may be rotated manually instead of being driven by the actuator.

A configuration other than that in the above-described embodiment may be employed as the swing control unit as long as it controls the swinging motion of the swing member 38 in accordance with the magnitude of the torque of the drive gear 36. FIG. 8 illustrates one such example. In this modification, the swing control unit includes a first stepped portion 71, a second stepped portion 72, a first engagement portion 73, and a second engagement portion 74.

The first stepped portion 71 and the second stepped portion 72 extend linearly along the inner surface 31a of the base 31, while protruding inward from the inner surface 31a. The first stepped portion 71 and the second stepped portion 72 are symmetrical with respect to the vertical plane VP. The first stepped portion 71 and the second stepped portion 72 are inclined in directions opposite to each other with respect to the vertical plane VP such that the distance therebetween increases toward the upper side.

A region interposed between the first stepped portion 71 and the second stepped portion 72 serves as a swing allowing region Z0, which allows the intermediate member 37 to swing from the first position to the second position and allows the intermediate member 37 to swing from the second position to the first position. A region on the opposite side of the first stepped portion 71 from the swing allowing region Z0 serves as a first swing restricting region Z1, which restricts the swinging motion of the intermediate member 37 from the first position to the second position. A region on the opposite side of the second stepped portion 72 from the swing allowing region Z0 serves as a second swing restricting region Z2, which restricts the swinging motion of the intermediate member 37 from the second position to the first position.

The first engagement portion 73 and the second engagement portion 74 protrude outward from two locations on the swing member 38 that are above the rotation shaft 35 and separated from each other in the circumferential direction of the rotation shaft 35.

As shown in FIG. 8, when the swing member 38 is located at the first position, the distal end of the first engagement portion 73 is located in the first swing restricting region Z1 and at a position close to the first stepped portion 71. Although not illustrated, when the swing member 38 is located at the second position, the distal end of the second engagement portion 74 is located in the second swing restricting region Z2 and at a position close to the second stepped portion 72. When the swing member 38 swings between the first position and the second position, the distal ends of the first engagement portion 73 and the second engagement portion 74 are both located in the swing allowing region Z0.

In the above-described modification, like or the same reference numerals are given to those components that are like or the same as the corresponding components in the above-described embodiment and detailed explanations are omitted.

According to this modification, similarly to the above-described embodiment, the swinging motion of the swing member 38 can be controlled in accordance with the magnitude of the torque of the drive gear 36.

Specifically, when the swing member 38 is located at the first position shown in FIG. 8, the distal end of the first engagement portion 73 is located at a position within the first swing restricting region Z1 that is close to the first stepped portion 71. The distal end of the second engagement portion 74 is located in the swing allowing region Z0. In this state, when the rotational direction of the drive gear 36 is switched and the swing member 38 tends to swing in the opposite direction, the distal end of the first engagement portion 73 is located in the first swing restricting region Z1 if the torque of the drive gear 36 is less than the prescribed value. The distal end of the first engagement portion 73 comes into contact with the first stepped portion 71, but is prevented from passing over the first stepped portion 71. Accordingly, the swinging motion of the swing member 38 from the first position to the second position is restricted.

When the rotational speed of the drive gear 36 increases from the above-described state so that the torque becomes greater than or equal to the prescribed value, the first engagement portion 73 passes over the first stepped portion 71. This passing over causes the first engagement portion 73 to enter the swing allowing region Z0, so that the swing member 38 is allowed to swing from the first position to the second position.

Then, immediately before the swing member 38 swings to the second position, the second engagement portion 74 passes over the second stepped portion 72 and enters the second swing restricting region Z2. After entering the second swing restricting region Z2, the distal end of the second engagement portion 74 is located at a position within the second swing restricting region Z2 that is close to the second stepped portion 72.

In this state, when the rotational direction of the drive gear 36 is switched and the swing member 38 tends to swing in the opposite direction, the distal end of the second engagement portion 74 is located in the second swing restricting region Z2 if the torque of the drive gear 36 is less than the prescribed value. The distal end of the second engagement portion 74 comes into contact with the second stepped portion 72, but is prevented from passing over the second stepped portion 72. Accordingly, the swinging motion of the swing member 38 from the second position to the first position is restricted.

When the rotational speed of the drive gear 36 increases from the above-described state and the torque becomes greater than or equal to the prescribed value, the second engagement portion 74 passes over the second stepped portion 72 and moves to the swing allowing region Z0. This passing over allows the swing member 38 to swing from the second position to the first position.

Then, immediately before the swing member 38 swings to the first position, the first engagement portion 73 passes over the first stepped portion 71 and enters the first swing restricting region Z1. After entering the first swing restricting region Z1, the distal end of the first engagement portion 73 is located at a position within the first swing restricting region Z1 that is close to the first stepped portion 71.

The first stopper 67 and the second stopper 68 may be omitted.

The power transmission mechanism 30 of the present disclosure can be used not only in vehicle air-conditioning registers but also in any product equipped with a mechanism that drives two driven members separately by means of power transmitted from a single power source. Such products include, for example, a console box that is installed within a passenger compartment and configured to be positionally adjustable in multiple directions. The multiple directions include, for example, the front-rear direction and the vertical direction.

A component, a device, or the like other than the rotary damper 46, for example, a hydraulic damper, a wave washer, or the like may be used as the resistance applying unit as long as the resistance applying unit is attached to the swing member 38 and applies resistance in the rotational direction to the intermediate gear 45.

In the above-described embodiment, the torque of the drive gear 36 is increased in response to an increase in the rotational speed of the drive gear 36 through the combination of the drive gear 36 and the intermediate gear 45 (rotary damper 46). Alternatively, the torque of the drive gear 36 may be increased by increasing the torque of the motor 21 through control of, for example, a current value of the motor 21. In this case, the resistance applying unit assists in increasing the torque or adjusts the magnitude of the torque.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A power transmission mechanism, comprising:
a rotation shaft configured to rotate about a central axis, a rotational direction of the rotation shaft being switchable;
a drive gear attached to the rotation shaft so as to rotate integrally therewith;
an intermediate member configured to swing about the rotation shaft between a first position and a second position in a rotational direction of the rotation shaft by a torque of the drive gear;
a first output portion configured to drive a first driven member by being connected to the intermediate member in a power transmittable manner when the intermediate member swings to the first position; and
a second output portion configured to drive a second driven member by being connected to the intermediate member in a power transmittable manner when the intermediate member swings to the second position.

2. The power transmission mechanism according to claim 1, wherein
the first output portion includes a rotatably supported first output gear,
the second output portion includes a rotatably supported second output gear,
the intermediate member includes a swing member, an intermediate gear, and a resistance applying unit,
the swing member is supported by the rotation shaft so as to be rotatable relative to the rotation shaft, and is configured to swing between the first position and the second position,
the intermediate gear is rotatably supported by the swing member while being meshed with the drive gear,
the intermediate gear is configured to
mesh with the first output gear when the swing member swings to the first position, and
mesh with the second output gear when the swing member swings to the second position, and
the resistance applying unit is attached to the swing member and applies resistance in a rotational direction to the intermediate gear.

3. The power transmission mechanism according to claim 2, further comprising a single motor including an output shaft, the single motor being configured to switch a rotational direction of the output shaft,
wherein the output shaft is coupled to the rotation shaft so as to rotate integrally therewith.

4. The power transmission mechanism according to claim 2, further comprising:
a first stopper that restricts the swing member from swinging in a direction away from the second position beyond the first position; and
a second stopper that restricts the swing member from swinging in a direction away from the first position beyond the second position.

5. The power transmission mechanism according to claim 2, wherein
the resistance applying unit increases a torque of the drive gear via the intermediate gear,
the power transmission mechanism further comprises a swing control unit configured to control a swinging motion of the swing member in accordance with a magnitude of a torque of the drive gear,
when the torque of the drive gear is less than a prescribed value set in advance, the swing control unit restricts the swinging motion of the swing member from the first position to the second position and restricts the swinging motion of the swing member from the second position to the first position, and
when the torque of the drive gear is greater than or equal to the prescribed value, the swing control unit permits the swinging motion of the swing member from the first position to the second position and permits the swinging motion of the swing member from the second position to the first position.

6. The power transmission mechanism according to claim 2, wherein
the resistance applying unit includes a rotary damper,
the rotary damper includes a rotatable shaft, and generates a torque using a viscous fluid when the shaft rotates, and
the intermediate gear is attached to the shaft so as to rotate integrally therewith.
